(19) United States
(12) Patent Application Publication
(10) Pub. No.: US 2006/0104615 A1
(43) Pub. Date: May 18, 2006

(54) Recording medium, method for storing and reproducing digital image medium data on the recording medium

(76) Inventors: Kun-Da Wu, Nantou City (TW); Guo-Zua Wu, Taichung City (TW); Jian-Ru Li, Chaojhou Township (TW); Meng-Han Tsai, Taipei City (TW); Wei-Zheng Lu, Chiayi City (TW)

Correspondence Address: LIN & ASSOCIATES INTELLECTUAL PROPERTY, P.O. BOX 2339, SARATOGA, CA, 95070-0339, US

(21) Appl. No.: 10/986,737

(22) Filed: Nov. 12, 2004

(51) Int. Cl. H04N 5/781

(52) U.S. Cl. 386/96; 386/125

(57) ABSTRACT

This invention provides a recording medium, and a method for storing and reproducing digital image medium data on the recording medium. It is applicable to a medium information reproducing system, and allows users to edit and store the digital image medium data. When reproducing a video image, the video image is accompanied by auxiliary audio data. Therefore, the reproduced medium data is more alive and attractive for the viewers. In addition, the recording medium supports various formats of video and audio data. Therefore, the recording medium can record various types of medium data for the users.

### FIELD OF THE INVENTION

The present invention relates to a recording medium and a method for storing and reproducing digital image medium data on the recording medium. It is applicable to a medium information reproducing system for reproducing the medium data, and both video data and audio data can be simultaneously reproduced during the reproducing process.

### BACKGROUND OF THE INVENTION

Video images are an important medium for communication. Conventional cameras were first invented 150 years ago, and had gone through several phases of technical innovations. The new item in line is the digital camera, which greatly simplifies the image post-processing tasks in comparison with the images taken by the conventional camera. The image taken by a digital camera can be directly loaded into a display for instant viewing and future processing. Thereby, the reproduced image is more interesting and attractive for the viewers.

However, the current image display does not provide atmospheric audio to complement the silent image. It is desirable to integrate the audio to the image so that the atmosphere of the image viewing can be further enhanced, and the mood can be recreated.

### SUMMARY OF THE INVENTION

The present invention has been made to overcome the aforementioned drawback of current digital image viewing. The primary object of the present invention is to provide a method for storing and reproducing digital image medium data on a recording medium.

This method is applicable to a medium information reproducing system. The medium information reproducing system includes a memory unit, a video encoder/decoder (codec), and an audio codec. The method comprises the following four steps: (1) Partition and store data in a recording medium, such that the recording medium comprises at least a file system area and a medium data structure file area The file system area stores the file configuration data. The medium data structure file area comprises at least a recording medium header and a plurality of medium data areas. The recording medium header comprises recording medium management information. Each medium data area comprises at least a medium data header, a video data area, and an audio data area. The medium data header stores data management information. (2) Load the file configuration data into the memory unit, and read the recording medium management information, according to the starting address in the medium data structure file area, to determine if this recording medium matches a pre-determined data structure format. If not, process the next recording medium and return to step (1). (3) Read the data management information in the N^{th} medium data header, where N is an input number indicating a medium data area. (4) Set up the video codec and the audio codec, and reproduce the video data and the audio data stored in the N^{th} medium data area read in step (3).

The step (2) further comprise the following three sub-steps: (2a) Load the file configuration data into the memory unit, and read the starting address of the medium data structure file area. (2b) Read the recording medium management information with the starting address of the data structure file area into the memory unit. The recording medium management information includes at least a recording medium identifier, the total number of the medium data areas, and the starting address of each medium data area. (2c) Determine if the recording medium identifier is a pre-determined data format. If not, the invention continues to process the next recording medium and return to step (1); otherwise, the invention goes to step (3).

The set-up in the step (4) further comprises the following two sub-steps. (4a) Determining if the starting code of the header is correct. If not, the invention continues to process the next medium data and goes to step (3). (4b) Transmitting video format and video resolution to the video codec, and audio format and audio bit-rate to the audio codec. Then, continuing with the second part of the step (4), i.e., reproducing the medium data.

The reproducing data in step (4) can also further comprise the following four sub-steps. (4c) According to the starting address and the length of the video data area, and the starting address and the length of the audio data area, loading the video and the audio data into the memory unit, transmitting to the video codec and audio codec, respectively. (4d) Starting to reproduce until finish. (4e) Determining if the repeat mode is activated. If so, return to step (4d). (4f) Determining if continue to reproduce. If so, process the next data and go to step (3); otherwise, end up the process.

Another object of the present invention is to provide the recording medium that stores the medium data described above. The recording medium comprises a file system pack and a medium data structure file pack. The file system pack consists of a file configuration data, and the medium data structure file pack consists of a recording medium header and a plurality of medium data. The recording medium header comprises at least a recording medium identifier, the total number of the medium data, and the starting address of each medium data.

In addition, each medium data further comprises a medium data header, a video data and an audio data. The medium data header comprises at least video file management information, audio file management information, and reproducing management information. The video file management information comprises at least a header starting code, a video format, a video resolution, the total length of the video data, and the starting address of the video data. The audio file management information comprises at least an audio format, an audio bit-rate, the total length of the audio data, and the starting address of the audio data. The reproducing management information comprises at least a repeat mode indicating if the repeat mode is on, and a play time.

The medium information reproducing system may be a personal computer (PC) or a digital video/audio player, and the recording medium may be a compact disk (CD), a memory card, or a micro-harddisk. The video format may be joint photographic experts group (JPG), tag image file format (TIFF), graphics interchange format (GIF), portable network graphics (PNG), bitmap (BMP), PCX, or RAW. The audio format may be the layer-2 (MP2) or layer-3 (MP3) of the moving picture experts group (MPEG) defined by ISO, WAVE, or windows media audio (WMA).

The storing and reproducing method for the digital image medium data of the invention allows the user to store and edit the digital image medium data, as well as enhances the reviewing experience of the images by adding audio effects. In addition, the present invention also supports a plurality of video and audio formats so that the recording medium can be more widely applied.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a data structure of the recording medium according to the present invention.

FIG. 2 shows a data format of the recording medium header.

FIG. 3 shows the data structure of the medium data structure file area for a recording medium.

FIG. 4 shows a data format of the medium data header in a medium data structure file area.

FIG. 5 shows a data structure of a medium data structure file area in FIG. 3.

FIG. 6 shows a relationship between the present invention and a medium information reproducing system.

FIG. 7 shows a flowchart of the method for storing and reproducing digital image medium data on a recording medium according to the present invention.

FIG. 8 shows a flowchart illustrating the steps of identifying a recording medium according to the present invention.

FIG. 9A shows a flowchart illustrating the steps of setting video codec and audio codec according to the present invention.

FIG. 9B shows a flow chart of illustrating the step of reproducing video data and audio data according to the present invention.

### DETAILED DESCRIPTION OF THE PREFERRED EMBODIMENTS

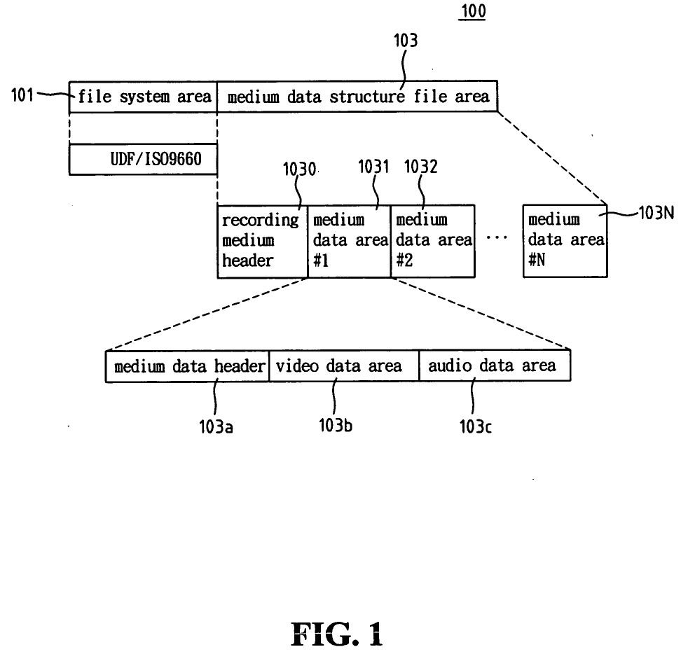

FIG. 1 shows a data structure of the recording medium according to the present invention. The data structure 100 for the recording medium comprises at least two portions, a file system area 101 and a medium data structure file area 103. File system area 101 stores the file system of universal disk format (UDF)/IS09660, where UDF is used in digital video disk (DVD), and ISO is used in other types of CD. Both UDF and IS09660 are read-only file systems. IS09660 is file system specification designed specifically for OS-independent file system, in order to increase the compatibility of the CDs. The CD using IS09660 file system can be used all type of operating systems. UDF is an industrial standard format in which DVD format movies are compressed using the MPEG2 and stored in an ordinary CD.

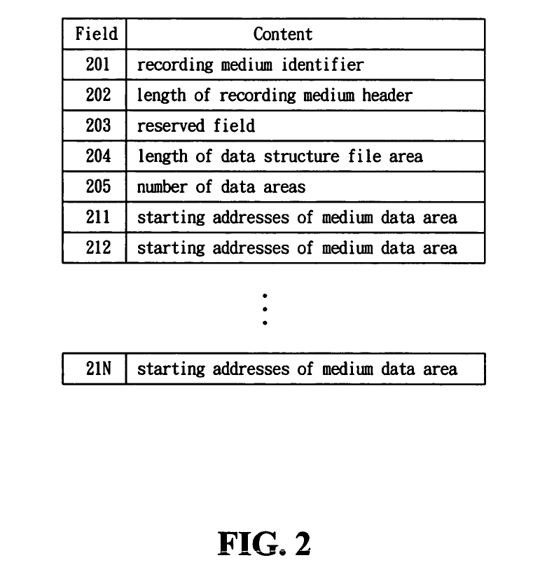

Medium data structure file area 103 comprises a recording medium header 1030 and a plurality of medium data areas 1031-103N. Recording medium header 1030 is for storing the recording medium management information (will be explained in FIG. 2). Each medium data area 1031-103N includes three parts: a medium data header 103a, a video data area 103b, and an audio data area 103c. Medium data header 103a stores the data management information, while video data area 103b and audio data area 103c store the video data and audio data, respectively.

FIG. 2 shows a data format for the recording medium header 1030. As shown in FIG. 2, field 201 stores a recording medium identifier, field 202 stores the length of recording medium header 1030, field 203 is a reserved field, field 204 stores the length of data structure file area, field 205 stores the number of data areas, and fields 211-21N store the starting addresses of medium data areas 1031-103N.

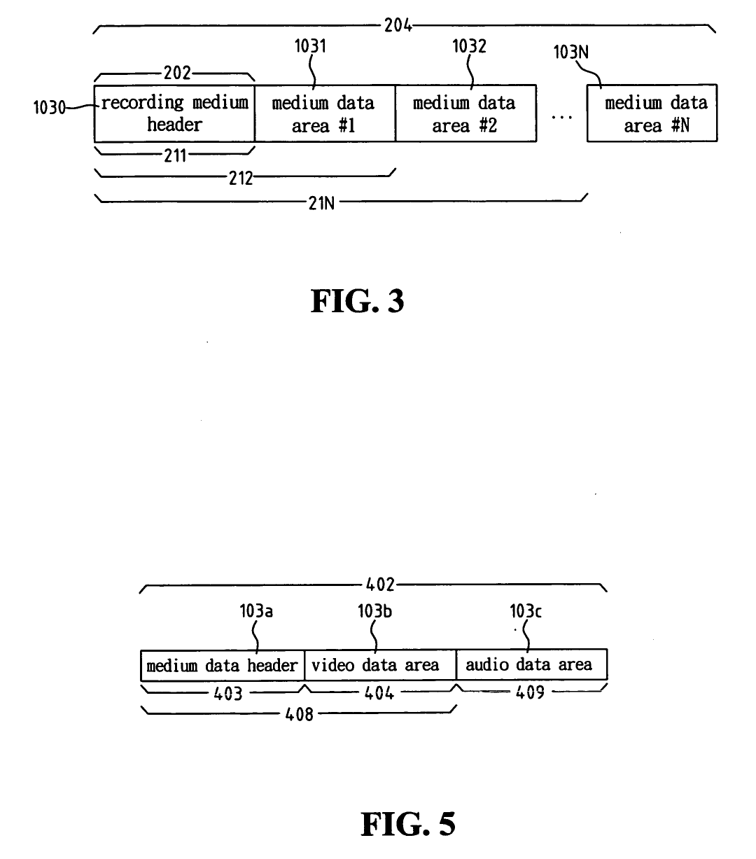

FIG. 3 shows the data structure of the medium data structure file area 103 in a recording medium. The reference numbers in the FIG. 3 are in accordance with the definitions of each field shown in FIG. 2.

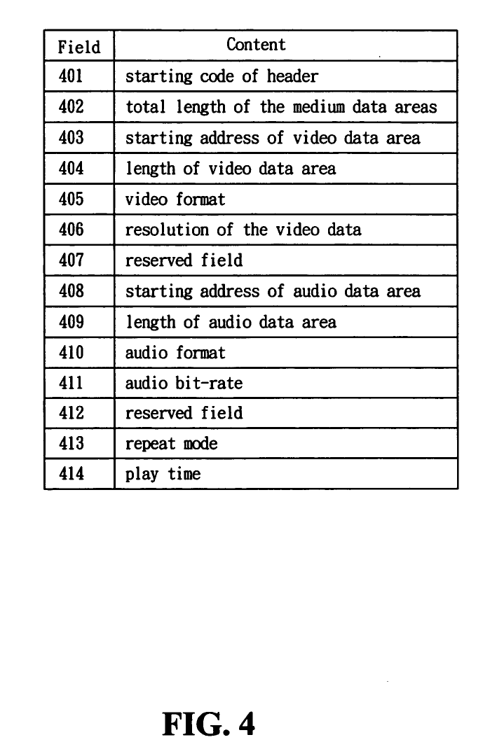

FIG. 4 shows a data format for the medium data header 103a. As shown in FIG. 4, field 401 stores the starting code of header 103a, field 402 stores the total length of the medium data areas 1031-103N, field 403 stores the starting address of video data area 103b, field 404 stores the length of video data area 103b, field 405 stores the video format, field 406 stores the resolution of the video data, field 407 and field 412 are reserved fields, field 408 stores the starting address of audio data area 103c, field 409 stores the length of audio data area 103c, field 410 stores the audio format, field 411 stores the audio bit-rate, field 413 stores the repeat mode, and field 414 stores the play time. The video format stored in field 405 includes JPG, TIFF, GIF, PNG, BMP, PCX, and RAW. The audio format stored in field 410 may include MP2, MP3 of MPEG defined by ISO, WAVE, and WMA.

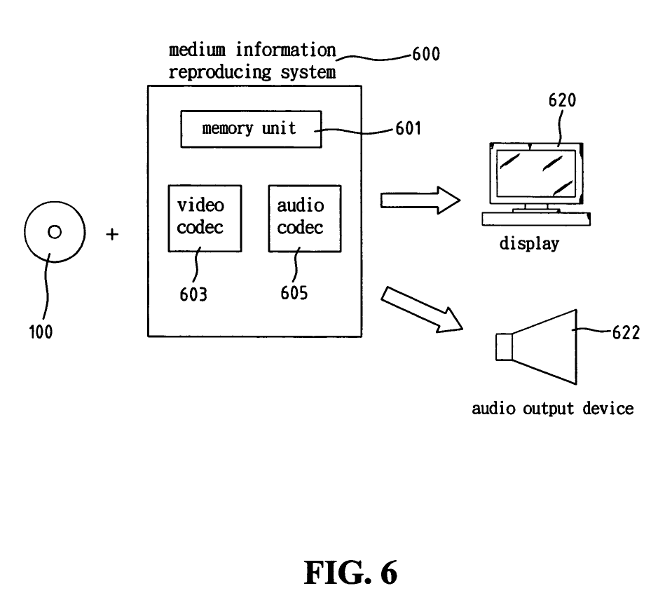

FIG. 5 shows the data structure of a medium data area 103N in FIG. 3. The reference numbers in the FIG. 5 are in accordance with the definitions of each field shown in FIG. 4.

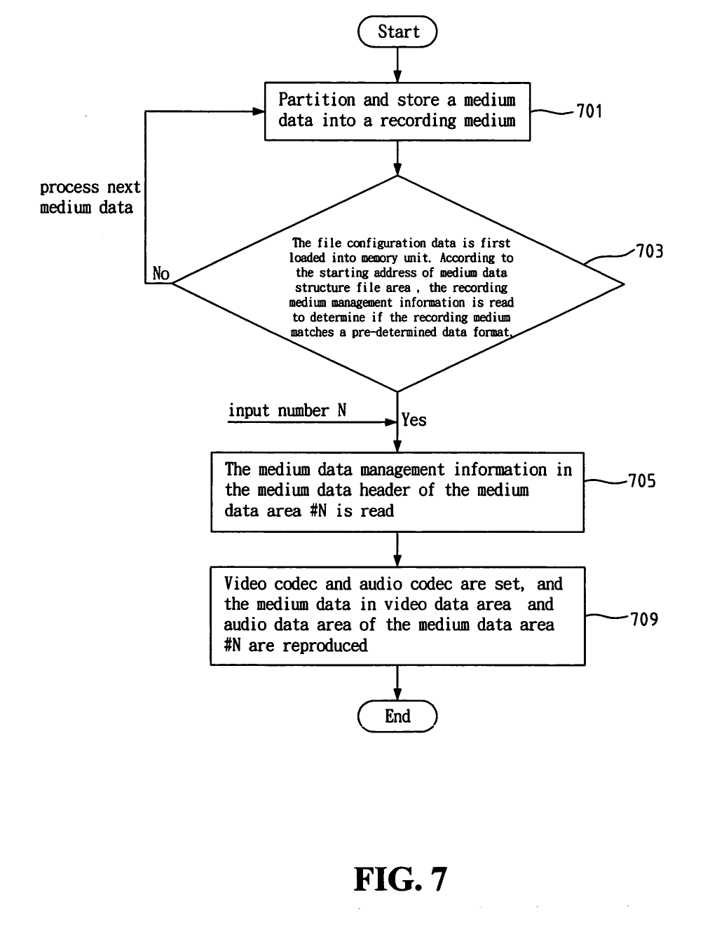

FIG. 6 shows a relationship between the present invention and a medium information reproducing system. Medium information reproducing system 600 includes a memory unit 601, a video codec 603, and an audio codec 605. Medium information reproducing system 600 reads medium data from a recording medium 100. After having decoded the medium data, medium information reproducing system 600 reproduces the video and audio data on a display 620 and an audio output device 622, respectively. Medium information reproducing system 600 may be a PC or a digital image player, and recording medium 100 may be a CD, a memory card, or a micro-harddisk. The memory card may include a compact flash (CF) card, a secure digital (SD) card, a XD-picture card, a smart media (SM) card, and a multi-media card (MMC).

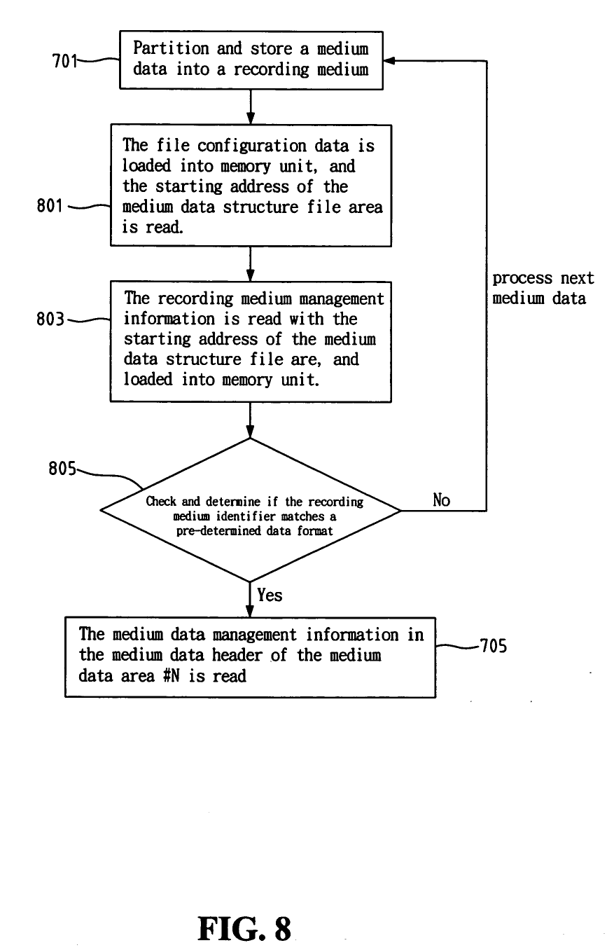

FIG. 7 shows a flowchart of the method for storing and reproducing digital image on a recording medium according to the present invention. In order to describe the followings, FIG. 1-FIG. 7 are simultaneously referred to. The present invention is applicable to a medium information reproducing system 600, which includes a memory unit 601, a video codec 603 and an audio codec 605. The method of the present invention comprises the following steps: Step 701 is to partition and store a medium data into a recording medium 100, such that the recording medium 100 at least comprises a file system area 101 and a medium data structure file area 103. File system area 101 stores the file configuration data. Medium data structure file area 103 comprises at least a recording medium header 1030 and a plurality of medium data areas 1031-103N. Recording medium header 1030 stores the recording medium management information. Each medium data area comprises at least a medium data header 103a, a video data area 103b, and an audio data area 103c. Medium data header 103a stores the medium data management information.

In step 703, the file configuration data is first loaded into memory unit 601. According to the starting address of medium data structure file area 103, the recording medium management information is read to determine if the recording medium matches a pre-determined data format. If not, the invention continues to proceed the next recording medium, then returns to step 701; otherwise, recording medium identifier 201 matches a pre-determined data format, and the invention proceeds the step 705. In step 705, the medium data management information in the medium data header of the medium data area #N is read according to an input number N. In step 709, video codec 603 and audio codec 605 are set, and the medium data in video data area 103b and audio data area 103c of the medium data area #N are reproduced.

The data management information for the N^{th} medium data comprises a video file management information, an audio file management information, and a reproducing management information. The video file management information comprises a header starting code 401, a video format 405, a video resolution 406, the total length 404 of a video data area, and the starting address 403 of a video data area. The audio file management information comprises an audio format 410, the total length 409 of an audio data area, the starting address 408 of an audio data area, and an audio bit-rate 411. The reproducing management information comprises a repeat mode 413 and a play time 414.

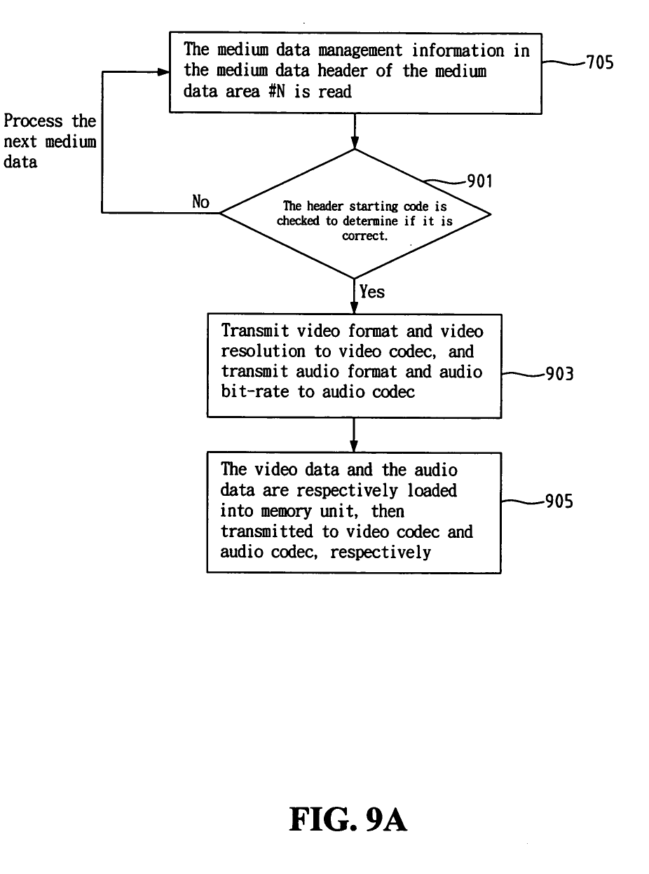

FIG. 8 shows a flowchart illustrating the steps of identifying a recording medium. In step 801, the file configuration data is loaded into memory unit 601, and the starting address of the medium data structure file area 103 is read. In step 803, the recording medium management information is read with the starting address of the medium data structure file area 103, and loaded into memory unit 601. The recording medium management information comprises at least a recording medium identifier 201, the number of medium data areas 205, and the starting addresses 211-21N of medium data areas. In step 805, this invention checks and determines if the recording medium identifier 201 matches a pre-determined data format. If not, the current recording medium is skipped, and the invention continues to proceed the next recording medium and returns to step 701; otherwise, the invention goes to step 705.

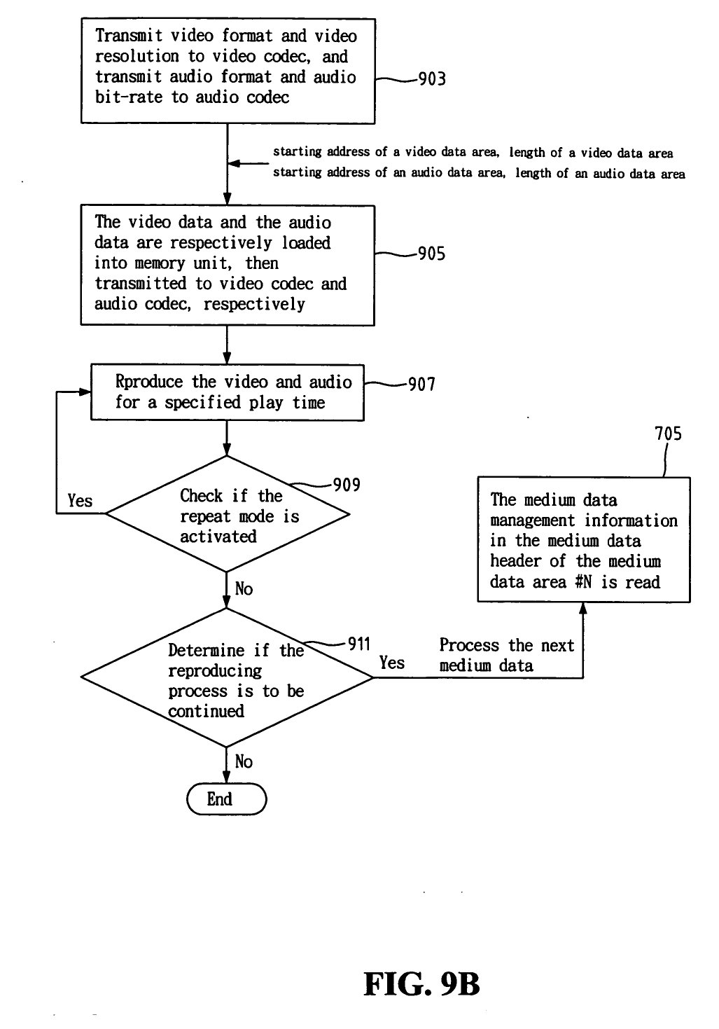

FIG. 9A shows a flowchart illustrating the steps of setting video codec and audio codec. In step 901, the header starting code 401 is checked to determine if it is correct. If not, the current data is skipped, and the invention continues to process the next data and goes to step 705. Otherwise, the invention takes the step 903 to transmit video format 405 and video resolution 406 to video codec 603, and transmit audio format 410 and audio bit-rate 411 to audio codec 605. Finally, it goes to step 905.

FIG. 9B shows a flowchart illustrating the steps of reproducing video data and audio data. In step 905, the video data and the audio data are respectively loaded into memory unit 601 according to the starting address 403 of a video data area, the length 404 of a video data area, the starting address 408 of an audio data area, and the length 409 of an audio data area. The video and audio data in memory unit 601 is then transmitted to video codec 603 and audio codec 605, respectively. In step 907, the invention starts to reproduce the video and audio for a specified play time 414. In step 909, the invention checks if the repeat mode is activated. If so, it returns to step 907; otherwise, it takes step 911 to determine if the reproducing process is to be continued. If so, it continues to process the next data and goes to step 705; otherwise, it ends up the reproducing process.

In summary, the present invention allows the user to store and edit digital medium data by means of the structure of the recording medium. When the video images are displayed, an accompanying audio data can also be simultaneously reproduced to enhance the viewing experience of the digital video images. In addition, users can set up the reproducing time and modes of the corresponding audio data for a video image. Therefore, users can enjoy their lives that have been recorded.

Although the present invention has been described with reference to the preferred embodiments, it will be understood that the invention is not limited to the details described thereof Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for storing and reproducing digital image medium data on a recording medium, said method being applicable to a medium information reproducing system having a memory unit, a video codec, and an audio codec, wherein said method comprises the steps of:
(1) partitioning and storing a medium data in a recording medium, such that said recording medium comprises at least a file system area and a medium data structure file area, said file system area storing a file configuration data, said medium data structure file area further comprising at least a recording medium header and a plurality of medium data areas, said recording medium header storing a recording medium management information, and each said medium data area comprising at least a medium data header, a video data area, and an audio data area, said medium data header storing a medium data management information;
(2) loading said file configuration data into said memory unit, and reading said recording medium management information according to the starting address in said medium data structure file area to determine if said recording medium matching a pre-determined data structure format, if not, processing a next recording medium and returning to step (1);
(3) reading a recording medium management information in a corresponding medium data header according to an input number for a specified recording medium data area; and
(4) setting said video codec and said audio codec, and reproducing the video and audio data stored in said specified recording medium data area.

2. The method as claimed in claim 1, wherein said step (2) further comprises the steps of:
(2a) loading said file configuration data into said memory unit, and reading the starting address of said medium data structure file area;
(2b) reading said recording medium management information from said starting address of said medium data structure file area into said memory unit, said recording medium management information comprising at least a recording medium identifier, the total number of said medium data areas, and the starting address of each medium data area; and
(2c) determining if said recording medium identifier macthing a pre-determined data structure format, if not, processing a next recording medium and returning to step (1), otherwise, continuing the step (3).

3. The method as claimed in claim 1, wherein said data management information of the step (3) further comprises a video file management information, an audio file management information, and a reproducing management information.

4. The method as claimed in claim 3, wherein said video file management information further comprises a header starting code, a video format, a video resolution, the length of said video data area, and the starting address of said video data area; said audio file management information further comprises an audio format, the length of said audio data area, the starting address of said audio area, and an audio bit-rate; and said reproducing management information further comprises a repeat mode and a play time.

5. The method as claimed in claim 1, wherein said setting video codec and audio codec in said step (4) can further comprises the steps of:
(4a) determining if said starting code of said data header being correct, if not, processing a next medium data and returning to the step (3); and
(4b) transmitting said video format and said video resolution to said video codec, and said audio format and said audio bit-rate to said audio codec, continuing said reproducing in the step (4).

6. The method as claimed in claim 1, wherein said reproducing of the step (4) further comprises the steps of:
(4c) according to said starting address and said length of said video data area, and said starting address and said length of said audio data area, loading said video data and said audio data into said memory unit, and transmitting said videodata and said audio data to said video codec and said audio codec, respectively;
(4d) starting said reproducing for a period of siad play time;
(4e) determining if said repeat mode being activated, if so, returning to step (4d); and
(4f) determine if continuing to reproduce, if so, processing the next medium data and proceeding to step (3); otherwise, ending up the reproducing.

7. The method as claimed in claim 1, wherein said medium information reproducing system is a personal computer or a digital image/audio player.

8. The method as claimed in claim 1, wherein said recording medium is a compact disk, a memory card, or a micro-harddisk.

9. The method as claimed in claim 4, wherein said video format is JPG, TIFF, GIF, PNG, BMP, PCX, or RAW.

10. The method as claimed in claim 4, wherein said audio format is MP2, MP3 of MPEG defined by ISO, WAVE, or WMA.

11. A recording medium applicable to a medium information reproducing system, said recording medium comprising:
a file system pack containing a file configuration data; and
a medium data structure file pack containing a recording medium header and a plurality of medium data areas;
wherein said recording medium header further comprises a recording medium identifier, a number indicating the number of said medium data areas, and the starting address of each medium data area.

12. The recording medium as claimed in claim 11, wherein said data area further comprises a data header, a video data area, and an audio data area, said data header further comprises video file management information, audio file management information and reproducing management information.

13. The recording medium as claimed in claim 12, wherein said video file management information further comprises a header starting code, a video format, a video resolution, the length of a video data area, and the starting address of a video data area; said audio file management information further comprises an audio format, the length of an audio data area, the starting address of an audio data area, and an audio bit-rate, said reproducing management information further comprises a repeat mode and a play time.

14. The recording medium as claimed in claim 13, wherein said video format is JPG, TIFF, GIF, PNG, BMP, PCX, or RAW.

15. The recording medium as claimed in claim 13, wherein said audio format is MP2, MP3 of MPEG defined by ISO, WAVE, or WMA.
